(19) United States
(12) Patent Application Publication
(10) Pub. No.: US 2009/0097472 A1
(43) Pub. Date: Apr. 16, 2009

(54) Method and apparatus for optimizing telephony communications

(76) Inventor: Afzal Hossain, San Jose, CA (US)

Correspondence Address: David Giglio, Attorney at Law, 231 Elizabeth Street, Utica, NY, 13501, US

(21) Appl. No.: 11/973,937

(22) Filed: Oct. 11, 2007

(51) Int. Cl. H04L 12/28

(52) U.S. Cl. 370/352; 370/401

(57) ABSTRACT

There is provided a method and apparatus for determining and optimizing a transmission route for a phone call. The phone call may be either local or long distance. For a local phone call the voice data is transmitted via known local methods. For a long distance phone call, middleware determines an optimal internet terminal service provider for carrying or transmitting the voice data. The middleware determines optimal internet terminal service provider by performing a comparative analysis of several internet terminal service providers according to cost and transmission quality.

### FIELD OF THE INVENTION

The present invention relates generally to the field of telecommunications and, more particularly, to a method and apparatus for optimizing the routing of telephone calls.

### BACKGROUND OF THE INVENTION

The telecommunications industry is one of the heavily regulated industries in the world. In 1996, the United States deregulated the industry of telecommunications. Many countries followed suit in deregulating the industry. This deregulation presented opportunities for competition and innovation.

In today's market, telecommunication services in most homes and small businesses have combination of up to four or even more independent services. There could be many independent service providers for each of these un-bundled services. As an example, a typical home may have a local service provider, a long-distance or international service provider, a broadband service provider, and a cable or satellite audio-video service provider. Each service provider may be independent from one another.

In the past, the telecommunications networks were fully circuit switched. In circuit switching technology, a physical electronic link is established through various nodes and links between the caller and the caller recipient. That link is maintained during the call and dismissed only when the call is ended.

Circuit switching subsequently gave way to more efficient packet switching technologies in the 1980s and 1990s. In packet switching, the voice data is digitized and converted into small packets of data which is then exchanged between the two endpoint phone devices. The requirement of an established fixed link between the two endpoint phone devices during the phone call was relaxed. The actual voice data packets of a call could be routed through one or more alternative paths or links during a single phone call.

A traditional public switched telephone network (PSTN) typically consists of a plurality of home telephones physically connected to a local switch room. The local switch room is remotely located within the vicinity of possibly thousands of homes. The switch rooms are connect to each other through a local network.

Call traffic going out of a local network is handled by one or more long distance switching facilities. The long distance switching facilities maintain trunks or high volume call capacity with other long distance switching facilities often located hundreds and thousands of miles away.

Until recently the entire network was circuit switched. However, with the advancements in satellite communications these networks now utilize mostly packet switching technology.

The cost of communications using the traditional PSTN model is the highest. Further, the traditional phone companies that maintain these communication lines and systems have become inefficient as well.

Also, traditional PSTN telecommunications technologies have limitations on delivering high voice quality. The network follows a time division multiplexing technology, where each voice channel is limited to up to 64 Kbps. A higher bit rate per voice channel could support music quality voice communications.

With the advent of the internet, packet switching telecommunications reached a new height. A new technology, known as Voice Over Internet Protocol or VoIP emerged. VoIP allows a voice channel to deliver music quality data rate of 96 Kbps or higher. In VoIP, the voice data packets travel over the internet, which is also referred to as a widely used public data network. The packets may also move through corporate internal data networks, which are also referred to local area networks.

With reference to public data networks, there is nobody who actually owns such networks. As such, the cost of transmitting phone calls over the internet is reduced in comparison to prior transmission methods. There presently exist several internet telephony protocols including SIP, H.323, AIX and RTP which establish and maintain phone calls.

Although VoIP has seen tremendous progress recently, the field is confusing chaotic. The fear of losing market shares by the traditional telecom companies and a lack of understanding of the telecom business by the Internet equipment vendors have kept the traditional telecom companies and internet vendors at a distance which has added to the chaotic growth.

There have been several attempts to lessen the cost of long distance phone calls during the past few years. One of these attempts has been through the use of calling cards. Many service providers provide these calling cards. A calling card is a card which has one or more local or toll free access phone numbers and an authentication code. A user originates a call by using a standard PSTN telephone and dialing of the access numbers. The PSTN switch is configured to deliver the call to the calling card service provider. The phone call usually reaches a computer server at the service provider's facility through PSTN gateway device.

After authentication, the call is routed through the internet or a private data network to a destination PSTN gateway. The destination PSTN switch room delivers the phone call to the recipient. A bi-directional voice channel is now established. When the call is terminated, the calling card account is billed.

One of the problems associate with the calling card method is that traditional direct dialing of the recipient phone number is abolished. As stated the user must first dial a local or toll free access number, followed by an authentication code, which is then followed by the entry of the recipient phone number. This a cumbersome process.

Further, calling cards are only good for a predetermined length of time. As such, phone calls made near the expiration of time on a calling card face the risk of being automatically terminated midway through a conversation.

Also, calling cards must be purchased at a store which requires additional effort. Finally, it is not uncommon for calling cards to become lost.

One variation of the calling card method is where an authentication code is given through a web-sit or by verbal methods. However, the user still faces the cumbersome access and authentication steps.

Another method now being deployed to reduce the costs of long distance phone calls is to use the internet method. In this method a telephone is connected to a home internet gateway using IEEE 802.3 RJ45 Category 5 cable, or 802.11 or 802.16 wireless means. The telephones can have one of several forms. It can be software running on a computing device or a digital telephone with data network interfaces such as IEEE802.3 or IEEE 802.11 or the like. The telephone may also be a regular analog phone with an internet adapter. Such an adapter is commonly known as an Analog Telephone Adapter (ATA). Usually, the telephones or ATA devices are provided to users by an Internet Telephony Service Provider (ITSP).

In addition to the ITSP, these phone services also depend on an Internet Service Provider (ISP). The ISP provides a home internet gateway device, which is typically a cable or DSL modem router. The home gateway device connects to another gateway device at the ISP's facility. This phone service is often an independent service provided by an ISP which cost additional money.

The telephone or ATA devices provided by the ITSPs merely connects to the internet through the ISP provided gateway devices. The phones actually connect over the internet to one or more telephone call servers at the ITSP facility, from the calls are routed to the destinations.

An internet phone or an ATA device has an Internet Provided (IP) address. Between two internet phones, calls are connected between two IP addresses. Since the phone are internet devices with IP addresses, traditional telephone numbers are not required. The phone addresses appear more like an email address than a traditional phone number. Thus, a problem arises when a caller needs to reach a traditional PSTN number or wants to receive a phone call from a PSTN caller. Since most callers are still in PSTN model, this presents a serious issue to the ITSP providers and users.

Another problem is that personal emergency numbers such as 911 and 311 are seriously compromised. Typically, phones are assumed to located in a particular house or building. Since an IP address can be located at any physical address the internet phone model of 911 and 311 lacks a sense of locality.

An incoming call from a PSTN caller presents another problem. A PSTN caller is familiar with dialing traditional telephone numbers. Therefore, a PSTN caller lacks the sense of the presence of an internet or IP address.

One attempt by the ITSP's to solve this problem is by using Direct Inward Dialing or DID. In the DID method, the ITSP leases several PSTN phone numbers at each area code from the appropriate authorities. The ITSP then assigns these numbers to the internet phone or ATA devices at the consumer premises. The computer based routing then equates an IP address of an internet phone with its assigned DID number. When a PSTN caller dials a DID number, that call is received by a phone server at the ITSP facility. It is the responsibility of the server to now locate the corresponding IP address of a DID number and complete the call accordingly.

The outgoing call to a PSTN number is a lesser but still significant problem. PSTN phones are physically connected to a local PSTN switch room by a twisted copper cable. Those phones must be reached by the PSTN network, which is generally considered a different system than the internet. Therefore, ITSPs must also have PSTN gateways to serve outgoing PSTN calls. The PSTN phones must be dialed like regular phone numbers even from an internet phone. Further where a caller ID must show on a recipient telephone, the internet side caller must have DID number to send as a caller ID. Therefore, the ITSP needs to simultaneously support traditional type phone number dialing and internet type phone dialing.

### SUMMARY AND OBJECTS OF THE PRESENT INVENTION

It is an object of the present invention to improve the field of telecommunications.

It is a feature of the present invention to provide a method and apparatus for which a home telephone can transmit and receive phone calls over the internet without the need for leasing or registering a special phone number indicative of an internet address.

It is another object of the present invention to optimize the transmission route of a phone call over the internet.

It is a further object of the present invention to optimize the cost of transmitting a phone call over the internet.

It is yet a further object of the present invention to optimize the transmission route of a phone call over the internet by determining the congestion of phone calls over a plurality of internet terminal service providers.

It is yet another object of the present invention to provide a traditional home phone which interfaces with both a local PSTN switch room and with an internet gateway.

It is still another object of the present invention to provide a traditional home phone which interfaces with an internet gateway suitable emergency phone number features.

It is another feature of the present invention to provide the cost benefits of voice over internet protocol in combination with the simplicity feature benefits of the public switched telephone networks in a single system.

It is still a further object of the present invention to provide cost effective voice over internet protocol while maintaining the simplicity of traditional dialing and service.

These and other objects and features are provided for in the present invention in which a method of transmitting a phone call from a traditional source phone to a destination phone includes the steps of entering data into the source phone which is indicative of the destination phone; determining whether the destination phone is local or long distance relative to the traditional source phone; transmitting voice data through a traditional phone connection where the destination phone is determined as local; transmitting voice data through an internet gateway where destination phone is determined as long distance; and determining an optimal route for the voice data that is transmitted through the internet gateway.

The step of determining an optimal route for the voice data includes the step of selecting an internet terminal service provider to carry the voice data. An internet terminal service provider may be selected according to cost of transmission, the quality of transmission or a comparative analysis of both among several providers.

These and other methods and features are provided where a traditional phone is connected to a local PSTN through a telephone adapter. The telephone adapter also includes a port for connecting to an internet gateway. Software disposed within the adapter controls the routing of an outgoing call. Local phone calls are routed to the local PSTN to be dealt with there by customary known methods.

Long distance calls and calls carrying high data rates are routed through the internet gateway and to a remote server. This allows music quality voice data to be transmitted to a traditional source phone.

The remote server of the present invention performs optimization algorithms to determine the optimal transmission route for data transmission. The remote server or another server within the system further includes software to manage accounts, system maintenance and other system non-data transmission functions.

### BRIEF DESCRIPTION OF THE DRAWINGS

The present invention will be understood and appreciated more fully from the following detailed description taken in conjunction with the drawings in which:

FIG. 1 is a block diagram depicting the flow of data in accordance with a preferred embodiment of the present invention;

FIG. 2 is a block diagram of a local configuration of the present invention in conjunction with an adaptation for a personal computer;

FIG. 3 is a flowchart diagram depicting preferred decision making and data transmission in accordance with a preferred embodiment of the present invention;

FIG. 4 is a flowchart diagram depicting the decision making and data transmission of FIG. 3 in conjunction with an accounting for voice data bit rate;

FIG. 5 is a flowchart diagram of decision making for determining an optimum transmission route for a long distance phone call;

FIG. 6 is a block diagram depicting the flow of data of FIG. 1 in conjunction with an endpoint auto provisioning configuration management system;

FIG. 7 is a block diagram depicting the flow of data of FIGS. 1 and 7 in conjunction with a remote logging and debugging support system;

FIG. 8 is a block diagram of a local configuration in accordance with the present invention depicting an interactive response system disposed with an adapter of the present invention;

FIG. 9 is a block diagram of a local configuration in accordance with the present invention depicting a memory system disposed with an adapter of the present invention; and

FIG. 10 is a block diagram of a local configuration in accordance with the present invention in which a plurality of local phone communicate with an adapter of the present invention.

### DETAILED DESCRIPTION OF THE PRESENT INVENTION

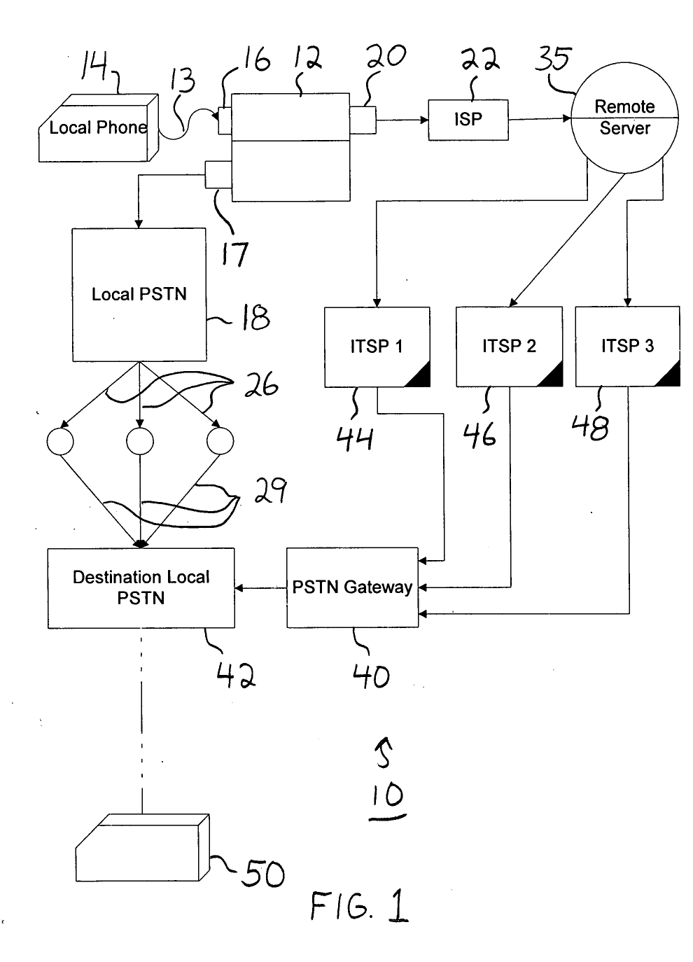

Turning now to FIG. 1 there is shown a calling system 10 in accordance with a preferred embodiment of the present invention. A traditional source phone 14, often referred to as a land line phone because it is physically connected by a twisted pair of cable 13 that is physically connected to public switched telephone network (“PSTN”) 18, is connected to an analog telephony adapter 12 at a first RJ11 port 16.

A second RJ11 port 17 physically connects the traditional source phone 14 to a local PSTN 18 as it always has done. The analog telephony adapter 12 further includes an RJ45 terminal 20 that is connected to a home internet gateway 22. Through the RJ45 port a Category 5 cable typically connects to an internet gateway. The internet or data network connection can also be provided with a Wi-Fi, Bluetooth, EDGE 802.11 or 802.16 wireless interface.

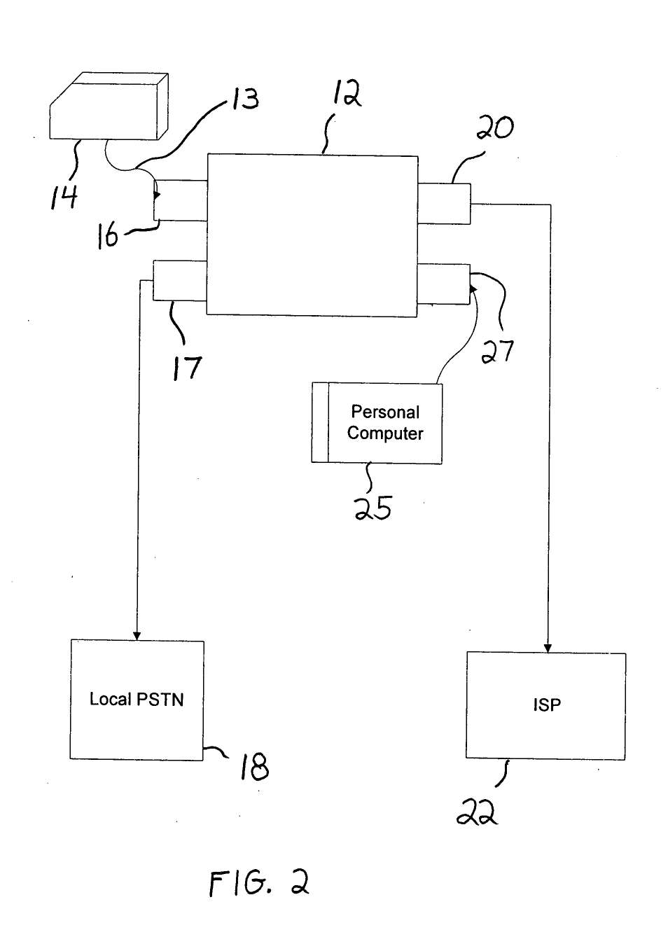

To one skilled in the art various modification may be made to the analog telephony adapter 12 including adding a separate RJ45 port 27 for adding a computer 25 or an additional analog telephony adapter to the system, which is depicted in FIG. 2.

Rather than using a traditional phone, a wireless or cordless phone may be implemented with the present invention. For a cordless phone, the interface may include a 900 MHz/2.4 GHz/5.8 GHz or other cordless phone interface.

The analog telephony adapter 12 includes embedded software which has routing capability that determines whether the outgoing phone call is local or long distance. Where the phone call is local, then the software routes the voice data via traditional routes to the local PSTN 18. The call is then routed through telecom trunks 26 which contain various nodes and links 29.

Where the outgoing phone call is long distance the software routes the outgoing phone call through the RJ45 terminal 20 to the home internet gateway 22 and onto a remotely located server 35 which contains server software.

The adapter 12 may also be embedded inside of a cable or DSL modem. In such a case, a cable or DSL modem may include two RJ11 telephone interface ports. One of the RJ11 telephone interface ports may be for the traditional phone, while the other may be for the outgoing local PSTN line. A 900 MHz/2.4 GHz/5.8 GHz cordless phone interface port or even a wireless phone interface port may replace the traditional telephone RJ11 interface port.

All of the audio or voice data is transmitted through voice over internet protocol (“VOIP”). In VoIP, the voice data packets travel over the internet, through an internet telephony service provider (“ITSP”) depicted as 44, 46 and 48, which is also referred to as a widely used public data network.

Prior to terminating at a destination phone, the voice data packets must be routed though a PSTN gateway 40 and onto a destination local PSTN 42, where the call is routed to a destination phone 50. It should be apparent that the destination phone may also be a wireless phone in which case destination local wireless antennae provides the destination local link.

One of the primary functions of the server software is to optimize the long distance phone call for quality and cost. When referring to long distance phone call, international phone calls are included.

The server 35 is physically located at a central location and is accessed over the public internet, or over a private data networks. There may be many servers throughout the system.

Since much of the telecommunications industry is deregulated, many companies provide service links to connect a source phone call with a destination phone. A long distance phone call may realize many service links during a single phone conversation with each service provider of a single link being compensated along the way by way of cost.

The service links in and among themselves each contain certain characteristics. Among these characteristics is congestion, cost and line quality.

Congestion simply means the number of phone calls per volume capacity per service link. Where a service link is congested, call data is going to be transmitted slower or there may be breaks in communication. Congestion may be constant for a service link or it may be time of day or otherwise sensitive to some external factor.

Cost also varies from one service link to another. The cost varies for a variety of reasons. For example, a certain transmission carrier owns the medium through which the data is transferred while the service provider leases a portion of that medium. The cost of using such a link may be based upon the cost of the lease. Another factor affecting cost may external factors such as the infrastructure of the service provider in which some service providers are less or more efficient. Other factors which affect cost may include local taxes that a service provider must pay to a certain government to provide service in such locality.

Line quality is often based on congestion with more congestion contributing to lower line quality. However, line quality may also be indicative of the technology used by the transmission carrier. Advanced technology results in better line quality while lesser technology results in poorer line quality. Other factors affecting line quality include system maintenance and the number of connectors within a system. A system with poor maintenance will result in poor quality. A system with a greater number of connectors will result in slower communications and more errors in data transfer as each connector decreases the efficiency of data transfer.

Upon initiation of a long distance phone call, the server software assesses these characteristics for each link from a source to a destination. The server software has the capability to perform real time assessment of congestion and cost. The server software also has the capability to determine line quality based upon a number of factors including dropped or externally interrupted phone calls.

The server software runs several optimization algorithms to balance and decide between the sometimes competing characteristics.

The server software then optimizes the transmission route both for quality and cost. Where the costs are the same or similar, the server software will typically look to the next set of factors which includes line quality and congestion.

The server software will often attempt to steer a phone call away from a line having poor quality. The server software utilizes this real time assessment and past accesses a database of all the service links for congestion.

The server software selects and guides the call data through one of the internet terminal service providers (“ITSP”) after optimization is determined. The server software keeps the selected ITSP connection open during the conversation. Each of the internet terminal service providers terminates at a PSTN gateway which decodes the data which is then transmitted to a destination local PSTN and onto the destination phone.

Rather than selecting an internet terminal service provider, the server may instead select and guide a call through one or more long distance carriers or a combination of internet terminal service providers and long distance carriers.

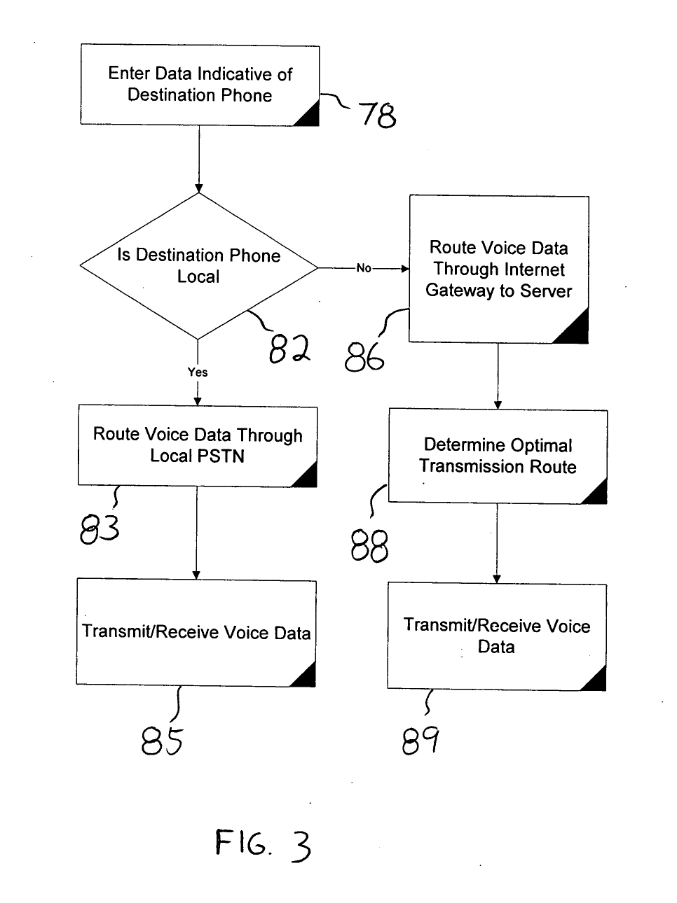

Referring now to FIGS. 3-5 there is shown a series of flowcharts depicting the actual flow of data and decision making in accordance with the present invention. Referring to first to FIG. 3, after a phone call number is entered, step 78, and transmission is set to begin, the adapter software determines the locality of the destination phone, step 80.

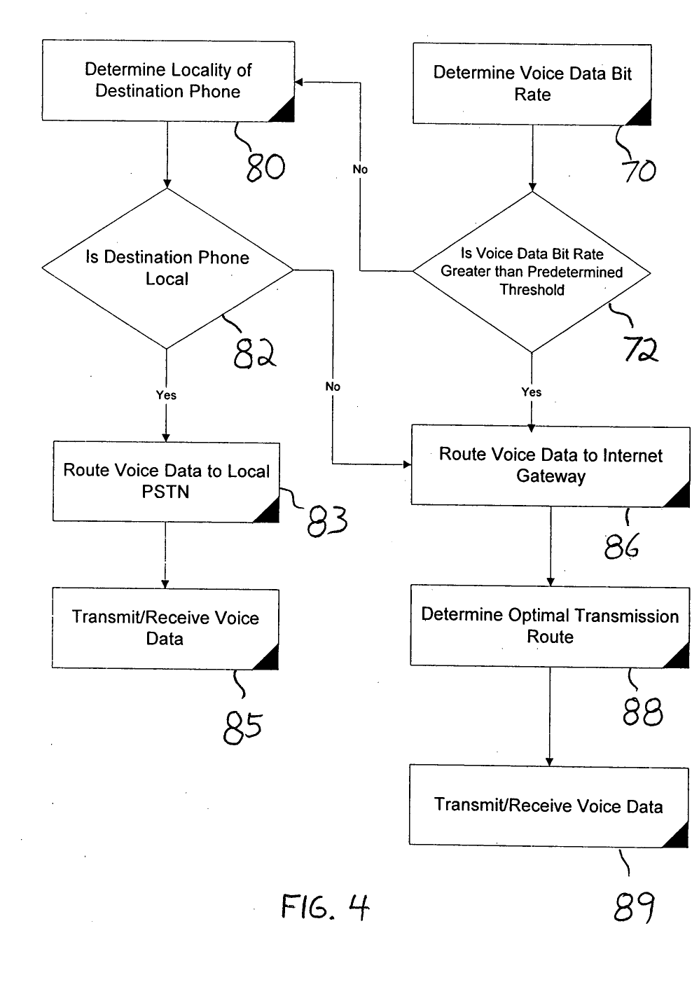

Referring quickly to FIG. 4, the adapter software may first determine the voice data bit rate, step 70. If the voice data bit rate is greater than a predetermined threshold, step 72, such as 64 Kbps, then the adapter software will route the voice data to the internet gateway, step 74, where it will be handled by the server 35 which will be described further herein. If the voice data bit rate is not greater than the predetermined threshold, then locality of the destination phone must be determined, step 80.

Looking at both FIGS. 3 and 4, the adapter software then determines whether the destination phone is local or long distance, step 82. If the destination phone is local, then the voice data is routed directly to the local PSTN, step 83. At that point, transmit and receive is accomplished with the destination phone, step 85.

If the destination phone is long distance, then the voice data is routed through the internet gateway and onto the server, step 86. The server software determines the optimal transmission route, step 88 and then transmit and receive is accomplished, step 89.

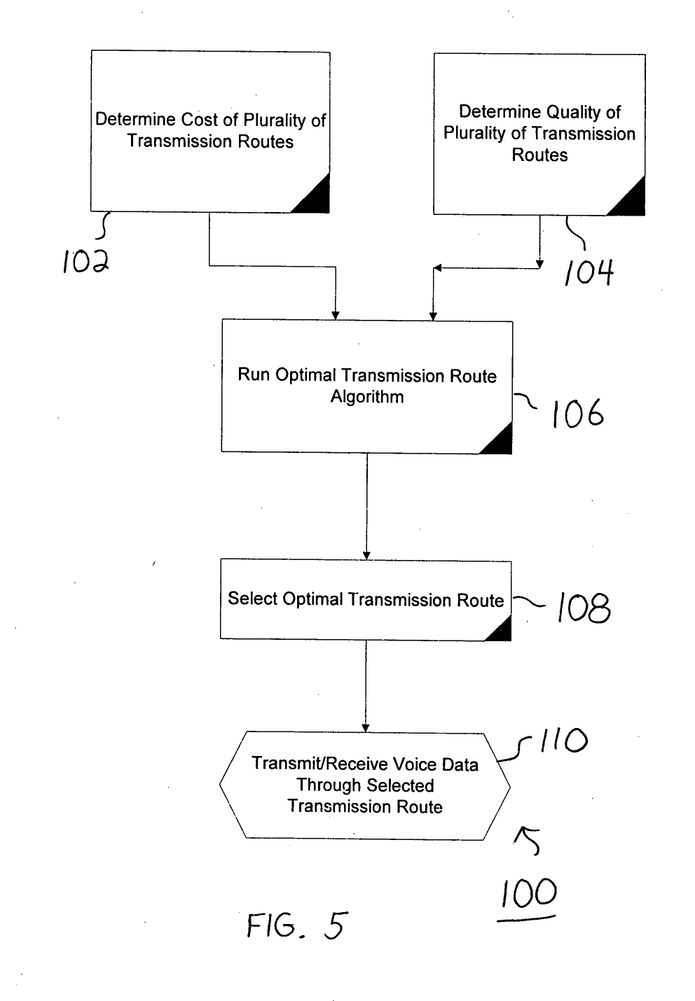

Turning now to FIG. 5, a flowchart of the server software 100 shows how a transmission route is selected. First, the server software 100 determines the cost and quality of a plurality of transmission routes, steps 102 and 104, respectively. Typically, the plurality of transmission routes, also depicted in FIG. 1 as ITSP 1 44, ITSP 2 46 and ITSP 3 48 are geographically selected.

Next, the server software 100 runs an optimal transmission route algorithm, step 106, utilizing, the cost and quality line determination of steps 102 and 104. The optimization algorithm allows the server software 100 to select an optimal transmission route, step 108, Finally, the server software 100 routes the voice data through the selected transmission route, 110, all the while keeping the selected transmission route open for the duration of the call.

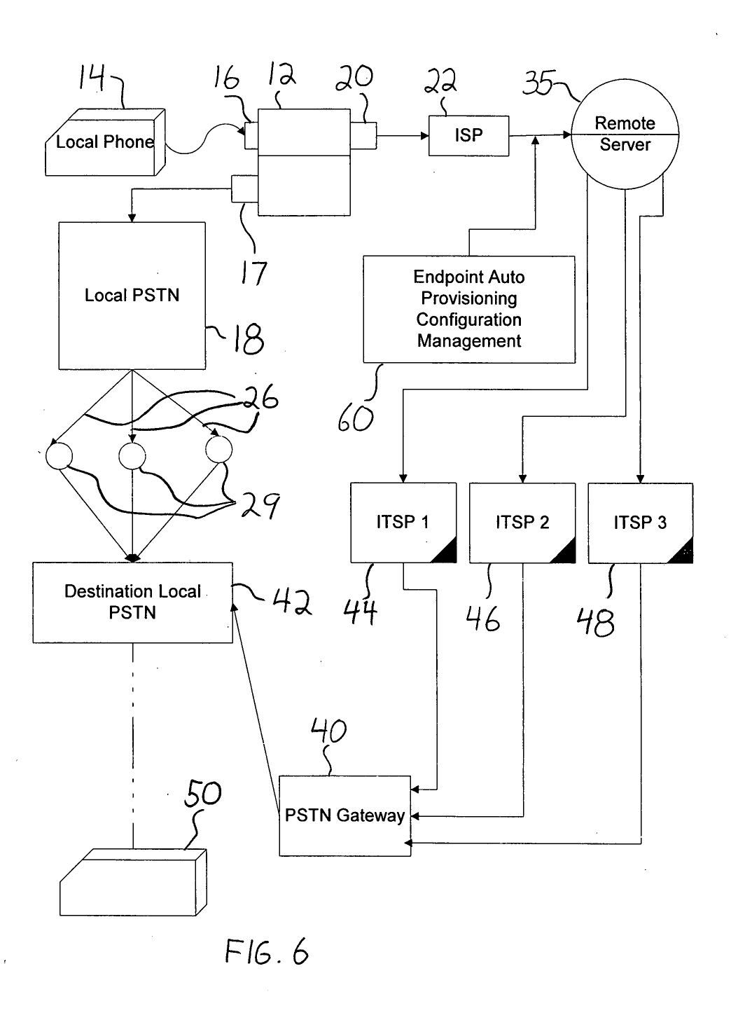

It is impractical to deploy a large number of analog telephone adapters at an end users home or office without remote management capability. In accordance with a feature of the present invention provisioning and configuration management remotely occurs over the internet or private data network. A special purpose server 60, depicted in FIG. 6, remotely manages the telephone adapter devices at an end users home or office. Such management includes updating the internal software code or voice application code at the end user premises.

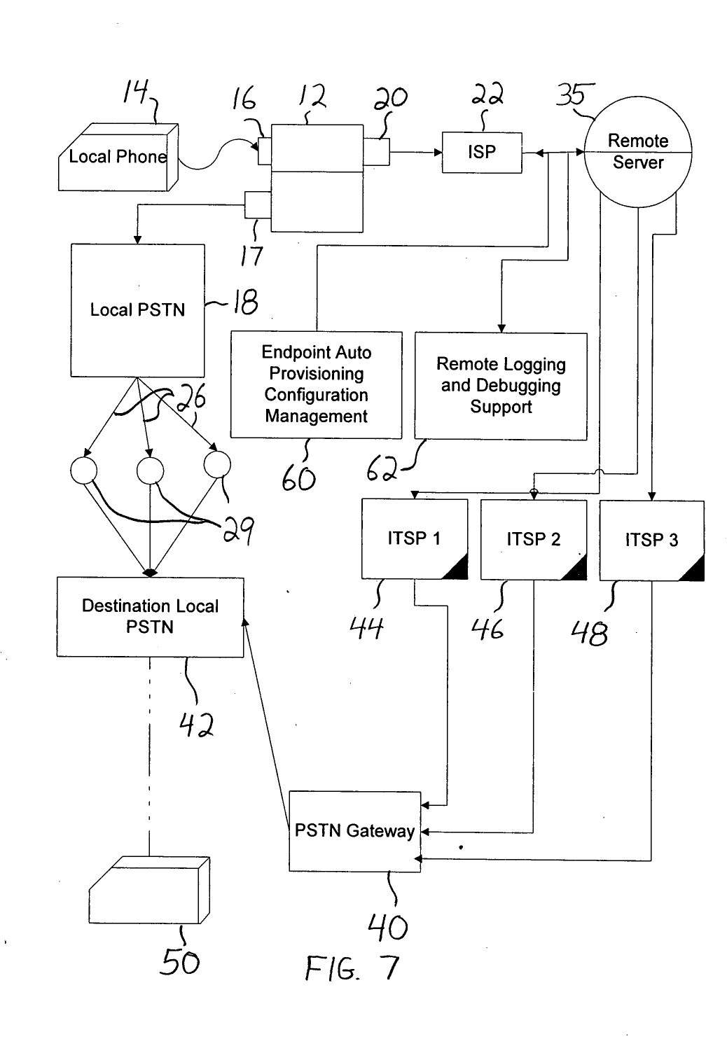

Additional special purpose servers 62, depicted in FIG. 7, located over the internet or data network log the activities of telephone adapter devices at an end users home or office. The logging capability is the basis of many value added features, such as remote customer support, problem debugging and assistance in accounting and billing.

Further special purpose servers also located over the internet or data network provides billing and accounting support. These servers interact with the other servers of the system. The combined knowledge of optimal routing, remote provisioning and client device activity logging are used to produce billing and accounting information.

Each of the mentioned servers can be hosted by a single computer or may be divided amount several computers to balance the load and manage the risk.

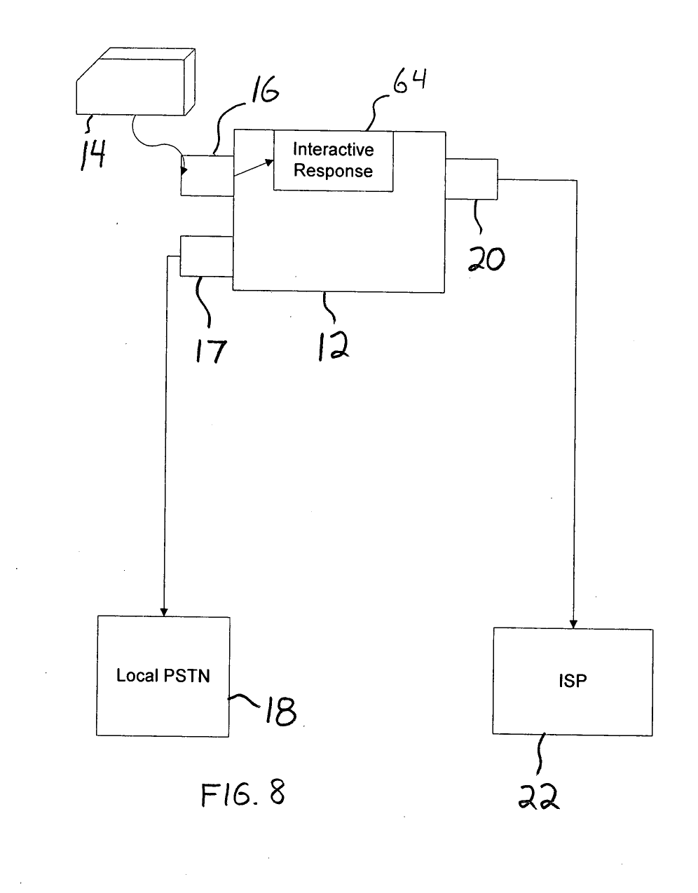

One of the features of the present invention includes intelligent call routing from a remote location. Referring now to FIG. 8, an interactive voice response system 64 residing withing the analog telephony adapter 12 provides a voice interface for call routing. The user calls his owns phone number from a remote location via the local PSTN 18. A voice prompt requests authentication and other prompts for the user desiring to make a long distance call via the analog telephony adapter 12. The analog telephony adapter 12 then routs the long distance call over the internet through the means shown and described herein.

The same long distance remote calling can also be achieved through electronic rather than voice prompts and entry.

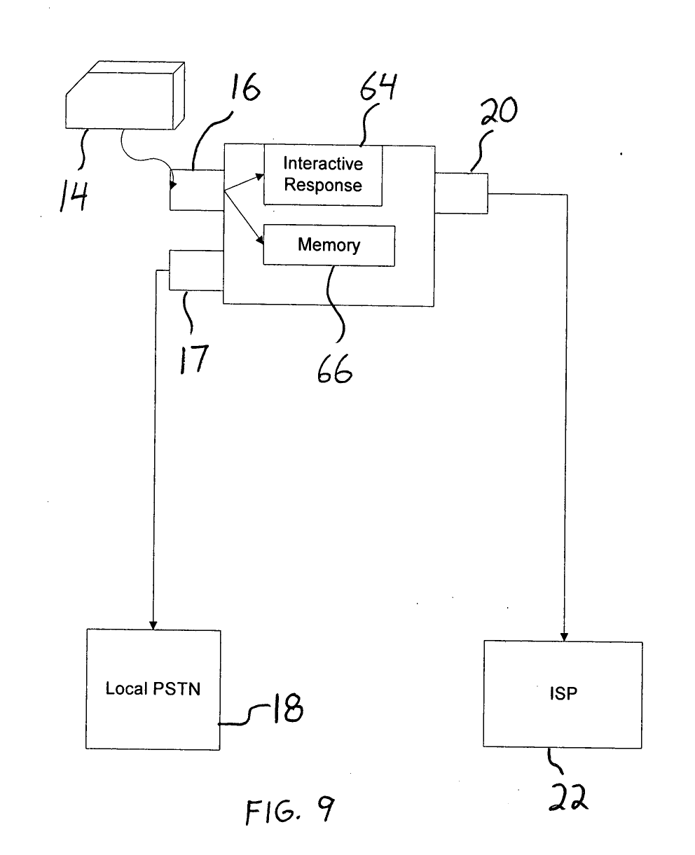

Another feature of the present invention is to provide a digital answering machine inside of the analog telephony adapter 12. Voice messages of external callers are saved to digital memory 66, depicted in FIG. 9, such as a flash memory. Stored messages can be retrieved locally or remotely using the interactive voice response system 64.

Yet another feature of the present invention is that the analog telephony adapter seamlessly supports 911, 311 or other locality sensitive calls. The adapter 12 parses the dialed digits to determine locality. The emergency numbers are treated as special numbers which must also be routed locally. As such, both local numbers and emergency numbers are handled seamlessly.

For most incoming phone calls to the traditional source phone from a long distance destination, the incoming phone calls will be routed as typically exists. The incoming phone call will come through the local PSTN and then to the traditional source phone.

One time where this varies is when the long distance destination phone has an adapter and uses a server in accordance with the present invention. In that case, the incoming call will be routed as described herein from the destination phone and through the server which serves the traditional source phone. From the server, the phone call will be routed through the internet into the traditional source phone.

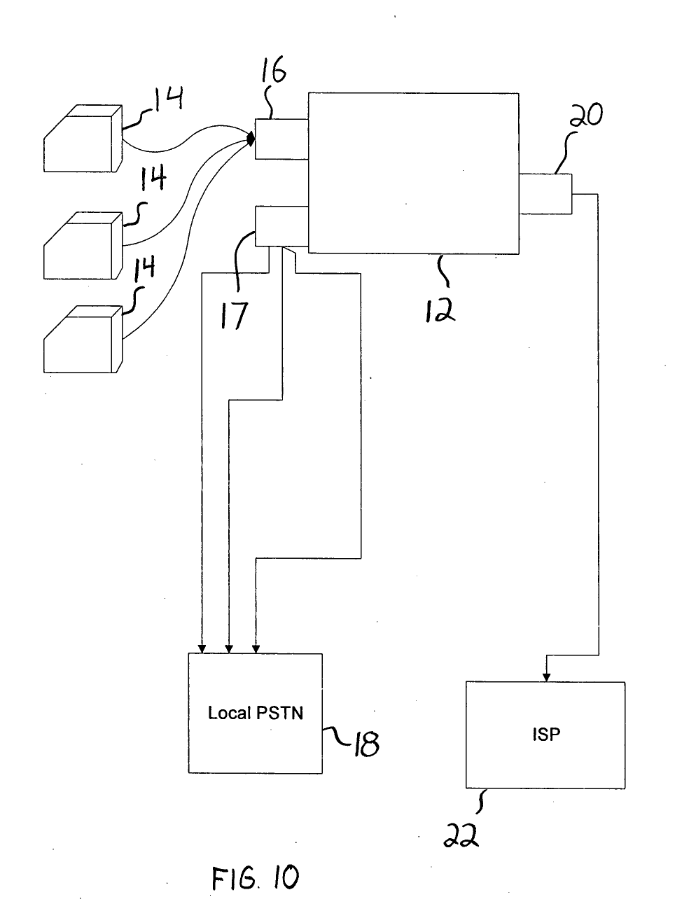

All of the features described herein can be provided to a small office or a home environment having a plurality of phones as depicted in FIG. 10.

Various changes and modifications, other than those described above in the preferred embodiment of the invention described herein will be apparent to those skilled in the art. While the invention has been described with respect to certain preferred embodiments and exemplifications, it is not intended to limit the scope of the invention thereby, but solely by the claims appended hereto.

What is claimed is:

1. A method of transmitting voice data from at least one source phone, wherein said at least one source phone does not include a direct inward dialing number from a local phone company, to at least one destination phone, said method comprising the steps of:
determining a locality of said at least one destination phone;
determining data bit rate of said voice data;
routing said voice data to either a local public telephone switch network or an internet gateway responsive to the steps of determining locality and determining voice data bit rate;
determining an optimal transmission route wherein said voice data is routed to said internet gateway; and
transmitting said voice data through said optimal transmission route.

2. The method of claim 1 wherein the step of determining an optimal transmission route for said voice data further includes the step of selecting at least one internet telephony service provider.

3. The method of claim 1 wherein the step of determining an optimal transmission route for said voice data further includes the step of selecting at least one long distance service provider.

4. The method of claim 1, wherein the step of determining an optimal transmission route for said voice data further includes the step of optimizing the cost of said at least one phone call, which further includes the steps of determining the cost of transmitting said voice data through at least one internet telephony service provider and at least one long distance service provider.

5. The method of claim 1, wherein the step of determining an optimal transmission route for said voice data further includes the step of optimizing the cost of said at least one phone call, which further includes the steps of determining the cost of transmitting said voice data through a plurality of internet telephony service providers.

6. The method of claim 1, wherein the step of determining an optimal transmission route for said voice data further includes the step of optimizing the cost of said at least one phone call, which further includes the steps of determining the cost of transmitting said voice data through a plurality of long distance service providers.

7. The method of claim 1, wherein the step of determining an optimal transmission route for said voice data further includes the step of optimizing the quality of transmission of said at least one phone call.

8. The method of claim 1, wherein the step of determining an optimal transmission route for said voice data further includes the step of determining the cost of said at least one phone call for a plurality of transmission routes, the step of determining the quality of transmission of said at least one phone call for said plurality of transmission routes and the step of performing a comparative analysis of said optimal cost and said optimal quality of transmission for said plurality of transmission routes.

9. The method of claim 1, wherein the step of entering data indicative of a destination phone further includes the step of remotely accessing the source phone from a remote phone.

10. A method of transmitting voice data from at least one source phone, wherein said at least one source phone does not include a direct inward dialing, to at least one destination phone, said method comprising the steps of:
determining a locality of said at least one destination phone;
routing said voice data to a local public telephone switch network when said locality is local, and routing said voice data to an internet gateway when said locality is long distance;
determining an optimal transmission route when said voice data is routed to said internet gateway; and
transmitting said voice data through said optimal transmission route.

11. The method of claim 10 wherein the step of determining an optimal transmission route for said voice data further includes the step of selecting at least one internet telephony service provider.

12. The method of claim 10 wherein the step of determining an optimal transmission route for said voice data further includes the step of selecting at least one long distance service provider.

13. The method of claim 10, wherein the step of determining an optimal transmission route for said voice data further includes the step of optimizing the cost of said at least one phone call, which further includes the steps of determining the cost of transmitting said voice data through at least one internet telephony service provider and at least one long distance service provider.

14. The method of claim 10, wherein the step of determining an optimal transmission route for said voice data further includes the step of optimizing the cost of said at least one phone call, which further includes the steps of determining the cost of transmitting said voice data through a plurality of internet telephony service providers.

15. The method of claim 10, wherein the step of determining an optimal transmission route for said voice data further includes the step of optimizing the cost of said at least one phone call, which further includes the steps of determining the cost of transmitting said voice data through a plurality of long distance service providers.

16. The method of claim 10, wherein the step of determining an optimal transmission route for said voice data further includes the step of optimizing the quality of transmission of said at least one phone call.

17. The method of claim 10, wherein the step of determining an optimal transmission route for said voice data further includes the step of determining the cost of said at least one phone call for a plurality of transmission routes, the step of determining the quality of transmission of said at least one phone call for said plurality of transmission routes and the step of performing a comparative analysis of said optimal cost and said optimal quality of transmission for said plurality of transmission routes.

18. The method of claim 10, wherein the step of entering data indicative of a destination phone further includes the step of remotely accessing the source phone from a remote phone.

19. An adapter for routing voice data from at least one local phone, wherein said at least one local phone does not include a direct inward dialing number, for at least one phone call to a destination phone, said adapter comprising:
at least one telephone access port for communicating with said at least one local phone;
at least one telephone outbound access port for communicating with a local public switched telephone network;
at least one internet access port for communicating with an internet gateway; and
adapter software which includes;
detection means for detecting the locality of said destination phone;
routing means which routs said voice data to said local public switched telephone network when said locality is local relative to said local phone, and which routs said voice data to said at least one internet access port when said locality is long distance relative to said local phone.

20. The apparatus of claim 19, wherein said at least one adapter further includes a second internet port which is interfaced with an internet gateway, wherein said second internet port communicates with a personal computer.

21. The apparatus of claim 19, wherein said adapter software further includes remote access means which allows a user to make a phone call through said at least one adapter from a remote location.

22. The apparatus of claim 21, wherein said remote access means further includes interactive voice response means for entering a phone number indicative of said phone call by voice signals.

23. The apparatus of claim 21, wherein said remote access means further includes an electronic response means for entering a phone number indicative of said phone call through electronic signals.

24. The apparatus of claim 19, wherein said at least one adapter further includes storage means for storing voice data on an unanswered incoming phone call.

25. The apparatus of claim 19, wherein said at least one adapter further includes storage means for storing voice data for a two-way phone call exchange.

26. An adapter for routing voice data from at least one local phone, wherein said at least one local phone does not include a direct inward dialing number, for at least one phone call to a destination phone, said adapter comprising:
at least one telephone access port for communicating with said at least one local phone;
at least one telephone outbound access port for communicating with a local public switched telephone network;
at least one internet access port for communicating with an internet gateway; and
adapter software which includes;
voice data bit rate detection means for detecting voice data bit rate on an outbound call;
data bit rate routing means which routs said voice data through said internet gateway when said voice data bit rate is greater than a predetermined rate;
locality detection means for detecting the locality of said destination phone;
routing means which routs said voice data to said local public switched telephone network when said locality is local relative to said local phone and said voice data bit rate is not greater than said predetermined rate, and which routs said voice data to said at least one internet access port when said locality is long distance relative to said local phone or when said voice data bit rate is greater than said predetermined rate.

27. The apparatus of claim 26, wherein said at least one adapter further includes a second internet port which is interfaced with an internet gateway, wherein said second internet port communicates with a personal computer.

28. The apparatus of claim 26, wherein said adapter software further includes remote access means which allows a user to make a phone call through said at least one adapter from a remote location.

29. The apparatus of claim 28, wherein said remote access means further includes interactive voice response means for entering a phone number indicative of said phone call by voice signals.

30. The apparatus of claim 28, wherein said remote access means further includes an electronic response means for entering a phone number indicative of said phone call through electronic signals.

31. The apparatus of claim 26, wherein said at least one adapter further includes storage means for storing voice data on an unanswered incoming phone call.

32. The apparatus of claim 26, wherein said at least one adapter further includes storage means for storing voice data for a two-way phone call exchange.

33. A server for routing voice data between at least one local phone, wherein said at least one local phone does not include a direct inward dialing number, and a destination phone, said server comprising:
local phone interface means which communicates said at least one local phone with said server through an internet gateway;
telecommunication system interface means which interfaces said server to a telecommunication system network; and
server software which includes:
cost determination means for determining the cost of transmitting voice data from said local phone to said destination phone over a plurality of transmission routes in said telecommunication system network;
quality determination means for determining the quality of said plurality of transmission routes; and
optimization selection means for selecting one of said plurality of transmission routes responsive to said cost determination and said quality determination.

34. The apparatus of claim 33, wherein said optimization selection means further includes an algorithm which performs a comparative analysis of said cost determination and said quality determination of transmission for said plurality of transmission routes.

35. The apparatus of claim 33, wherein said optimization selection means further includes cost determinations means for comparing the cost of transmission of said at least one phone call for a plurality of internet telephony service providers.

36. The apparatus of claim 33, wherein said server further includes accounting means for determining the billing information for said at least one phone call.

37. A server for routing voice data between at least one local phone, wherein said at least one local phone does not include a direct inward dialing number, and a destination phone, said server comprising:
local phone interface means which communicates said at least one local phone with said server through an internet gateway;
telecommunication system interface means which interfaces said server to a telecommunication system network; and
server software which includes:
cost determination means for determining the cost of transmitting voice data from said local phone to said destination phone over a plurality of transmission routes in said telecommunication system network; and
optimization selection means for selecting one of said plurality of transmission routes responsive to said cost determination.

38. The apparatus of claim 37, wherein said optimization selection means further includes an algorithm which performs a comparative analysis of said cost determination and said quality determination of transmission for said plurality of transmission routes.

39. The apparatus of claim 37, wherein said optimization selection means further includes cost determinations means for comparing the cost of transmission of said at least one phone call for a plurality of internet telephony service providers.

40. The apparatus of claim 37, wherein said server further includes accounting means for determining the billing information for said at least one phone call.

41. A telephone system which presents an apparatus for sending voice data from at least one local source phone to a destination phone, wherein said at least one local source phone does not include a direct inward dialing number from a local phone company, said telephone system comprising:
an adapter for routing voice data from said at least one local source phone, said telephone system comprising:
at least one adapter having at least one telephone access port for communicating with said at least one local source phone, at least one telephone outbound access port for communicating with a local public switched telephone network, and at least one internet access port for communicating with an internet gateway;
said at least one adapter further including adapter software which includes;
locality detection means for detecting the locality of a destination phone;
routing means which routs said voice data to said local public switched telephone network when said locality is local relative to said local phone, and which routs said voice data to said at least one internet access port when said locality is long distance relative to said at least one local source phone.
a server for routing voice data between said at least one local source phone and a destination phone, said server comprising:
local phone interface means which communicates said at least one local source phone with said server through an internet gateway;
telecommunication system interface means which interfaces said server to a telecommunication system network; and
server software which includes:
cost determination means for determining the cost of transmitting voice data from said at least one local source phone to said destination phone over a plurality of transmission routes in said telecommunication system network;
quality determination means for determining the quality of said plurality of transmission routes; and
optimization selection means for selecting one of said plurality of transmission routes responsive to said cost determination and said quality determination.

42. The apparatus of claim 41, wherein said adapter software further includes remote access means which allows a user to make a phone call through said at least one adapter from a remote location.

43. The apparatus of claim 42, wherein said remote access means further includes interactive voice response means for entering a phone number indicative of said phone call by voice signals.

44. The apparatus of claim 42, wherein said remote access means further includes an electronic response means for entering a phone number indicative of said phone call through electronic signals.

45. The apparatus of claim 41, wherein said at least one adapter further includes storage means for storing voice data on an unanswered incoming phone call.

46. The apparatus of claim 41, wherein said at least one adapter further includes storage means for storing voice data for a two-way phone call exchange.

47. The apparatus of claim 41, wherein said optimization selection means further includes an algorithm which performs a comparative analysis of said cost determination and said quality determination of transmission for said plurality of transmission routes.

48. The apparatus of claim 41, wherein said optimization selection means further includes cost determinations means for comparing the cost of transmission of said at least one phone call for a plurality of internet telephony service providers.

49. The apparatus of claim 41, wherein said server further includes accounting means for determining the billing information for said at least one phone call.

50. The apparatus of claim 41 wherein said server further includes remote injection software means for injecting configuration data into said at least one adapter.

51. The apparatus of claim 50, wherein said configuration data includes routing data to further define voice data flow between said local public switched telephone network and said internet gateway.

52. The apparatus of claim 41, wherein said adapter software further includes software requesting means for requesting configuration from said server.

53. The apparatus of claim 52, wherein said configuration data includes routing data to further define voice data flow between said local public switched telephone network and said internet gateway

54. A method of receiving voice data through an internet gateway, said method comprising:
interfacing a source phone with an adapter having at least one internet gateway access port, wherein said source phone does not require a direct inward dialing number;
interfacing said at least one internet gateway access port with a telecommunications network via a server;
detecting said long distance phone call by software within said adapter;
prompting said server to access said telecommunications network and receive said voice data; and
routing said voice data from said server to said local phone through said at least one internet gateway access port.

55. The method of claim 54, wherein the step of prompting said server further includes the step of detecting voice data having a bit rate above a predetermined threshold.

56. An adapter for routing voice data from a source phone for at least one phone call to a destination phone, said adapter comprising:
at least one telephone access port for communicating with said source phone;
at least one telephone outbound access port for communicating said source phone with a local public switched telephone network;
at least one internet access port for communicating said source phone with an internet gateway; and
adapter software which includes;
detection means for detecting the locality of said destination phone and for detecting whether said at least one phone call is to an emergency calling number;
routing means which routs said voice data to said local public switched telephone network when said locality is local relative to said source phone or when said at least one phone call is to said emergency calling number, and which routs said voice data to said at least one internet access port when said locality is long distance relative to said source phone.

57. The adapter of claim 56, wherein said detection means further includes means for determining the voice bit data rate of said voice data.

58. The adapter of claim 57, wherein said routing means routs said voice data to said at least one internet access port when said voice data is greater than a predetermined bit rate.

59. The apparatus of claim 56, wherein said adapter software further includes remote access means which allows a user to make a phone call through said at least one adapter from a remote location.

60. The apparatus of claim 59, wherein said remote access means further includes interactive voice response means for entering a phone number indicative of said phone call by voice signals.

61. The apparatus of claim 59, wherein said remote access means further includes an electronic response means for entering a phone number indicative of said phone call through electronic signals.

62. The apparatus of claim 56, wherein said at least one adapter further includes storage means for storing voice data on an unanswered incoming phone call.
